(19) United States
(12) Patent Application Publication
(10) Pub. No.: US 2014/0156748 A1
(43) Pub. Date: Jun. 5, 2014

(54) COMPUTERIZED COMMUNITY-BASED SOCIAL MEDIA MODERATION SYSTEMS AND METHODS

(71) Applicant: ONLINE WORKSHOP, INC., Chevy Chase, MD (US)

(72) Inventors: David B. Allen, Chevy Chase, MD (US); David J. Allsopp, Potomac, MD (US); Brian Leitner, Portland, OR (US)

(73) Assignee: ONLINE WORKSHOP, INC., Chevy Chase, MD (US)

(21) Appl. No.: 13/693,187

(22) Filed: Dec. 4, 2012

(51) Int. Cl. G06Q 10/10

(52) U.S. Cl. CPC G06Q 10/10
USPC 709/204

(57) ABSTRACT

Computerized community-based social media moderation systems and methods. A method includes selecting, using instructions executed by a processor, a plurality of juror computing devices, outputting the social media post to the plurality of juror computing devices for review of the social media post in light of the standard of the online community, and receiving inputs regarding the social media post from the plurality of juror computing devices. If the inputs regarding the social media post from the plurality of juror computing devices meet a predetermined condition, the outputting of the social media post to the plurality of social media user computing devices belonging to the online community is disabled. The selecting of the plurality of juror computing devices is performed according to a randomizing operation.

### BACKGROUND

1. Field

Embodiments of the present invention relate to computerized community-based social media content item moderation.

2. Description of the Related Art

Open political communication is a foundation of American society. We value open communication to such a degree that our constitution protects open political communication. In short, we believe that through open and liberal political communication, the marketplace of ideas will help us in our advancement.

As technology has advanced, so have opportunities for open political communication. A current technology that is widely used for political communication is social media. Social media is typically user-created content that is shared with other users. An example of social media being used for political communication is a website that caters to a particular political view and that features a discussion forum. Users of the discussion forum may create discussion forum posts discussing current political issues. A discussion forum thread or post may be started by a user and follow up posts may be posted within the thread. For example, a thread may be started reading “Who will win the presidential election this cycle?” and follow up posts may discuss particular candidates.

Sometimes, social media posts may go beyond healthy and open communication. For example, sometimes social media posts may rise to a level of being abusive (e.g., a personal attack by one user on another that is designed to cause emotional harm). Such posts typically add little to the discussion. To address this problem, an abuse alert may be provided with each post so that a user can flag a post as being abusive. Conventionally, posts flagged by abuse alerts may be reviewed by a particular person or set of persons (i.e., moderators or administrators). Thus, abusive posts can be curbed.

However, a problem presents itself in that the line between abusive posts and political speech may not be easy to determine. The users of the social media (i.e., the social media community) may collectively draw the line at one point, but the administrators of the social media may draw the line at a different point. For example, a follow up post in a discussion may state that “the author of this thread obviously has not been watching the news lately.” Such a post may have political speech value to the social media community, but may be removed from the discussion forum by administrators as being abusive. This problem is even further compounded by the fact that even a single administrator may interpret such posts one way on one day and another on a different day. With multiple administrators, the inconsistent application of specific standards of the online community can become even more pronounced. Accordingly, while the administrators seek to support the standards of the social media community, the administrators may actually error one way or the other in either allowing abusive posts or preventing open communication.

In light of the foregoing and other shortcomings in the art, it is desirable to provide computerized community-based social media content item moderation.

### BRIEF SUMMARY

According to an aspect of the invention, a computerized community-based social media moderation method is provided. The method includes receiving a social media post into a computerized memory of a server, outputting the social media post to a plurality of social media user computing devices of users belonging to an online community, and receiving an abuse alert regarding the social media post from one of the plurality of social media user computing devices. The abuse alert indicates a potential violation of a standard of the online community. The method further includes selecting, using instructions executed by a processor, a plurality of juror computing devices, outputting the social media post to the plurality of juror computing devices for review of the social media post in light of the standard of the online community, and receiving inputs regarding the social media post from the plurality of juror computing devices. If the inputs regarding the social media post from the plurality of juror computing devices meet a predetermined condition, the outputting of the social media post to the plurality of social media user computing devices belonging to the online community is disabled. The selecting of the plurality of juror computing devices is performed according to a randomizing operation.

The foregoing and other aspects will become apparent from the following detailed description when considered in conjunction with the accompanying drawing figures.

### BRIEF DESCRIPTION OF THE DRAWINGS

FIG. 1 is a schematic representation of a social media system according to an exemplary embodiment of the present invention.

FIG. 2 is a schematic representation of a website including a discussion forum according to an exemplary embodiment of the present invention.

FIG. 3 is a schematic representation of the website of FIG. 2.

FIG. 4 is a flowchart of operation of the website of FIG. 2 according to an exemplary embodiment of the present invention.

FIG. 5 is a flow chart of a randomizing operation according to an exemplary embodiment of the present invention.

FIGS. 6 and 7 are schematic representations of the website of FIG. 2.

### DETAILED DESCRIPTION

Reference will now be made in detail to embodiments of the present invention, examples of which are illustrated in the accompanying drawings, wherein like reference numerals refer to the like elements throughout. The embodiments are described below to explain the present invention by referring to the figures.

As used in the description of this application, the terms “a”, “an” and “the” may refer to one or more than one of an element (e.g., item or act). Similarly, a particular quantity of an element may be described or shown while the actual quantity of the element may differ. The terms “and” and “or” may be used in the conjunctive or disjunctive sense and will generally be understood to be equivalent to “and/or”. Elements from an embodiment may be combined with elements of another. No element used in the description of this application should be construed as critical or essential to the invention unless explicitly described as such. Further, when an element is described as “connected,” “coupled,” or otherwise linked to another element, it may be directly linked to the other element, or intervening elements may be present. Identifications of problems in the related art appearing in the Background section should generally be interpreted have been made by the inventors and not necessarily by others.

Embodiments of the present invention provide computerized community-based social media moderation. Social media posts of an online community are not only flagged for abuse by members of the online community, but the actual determinative review of the flagged social media post is performed by a jury from the online community. Accordingly, decisions regarding the standards of the online community may be more accurate relative to the community than decisions made by an administrator or group of administrators. Decisions may also be more consistent. Although the process for selecting the jury has the effect of being random, it also benefits from being designed to guard against certain groups of members of the community (e.g., the most active members) always being the decision makers regarding abusive posts. Accordingly, certain groups are less likely to take control of the direction of the community standards.

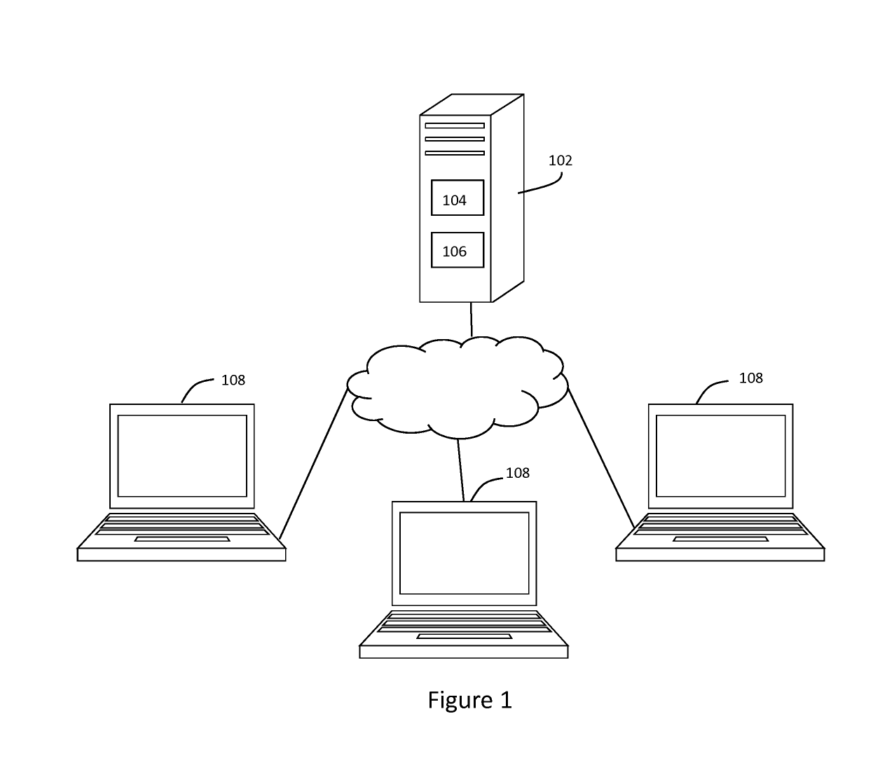

A computerized community-based social media moderation method may be implemented in a social media system accessible online. FIG. 1 is a schematic representation of a social media system 100 according to an exemplary embodiment of the present invention. The social media system 100 may include a server 102 hosting a social media application. The server 102 may include a memory 104 for storing instructions of the social media application. The server 102 may include a processor 106 for executing the instructions of the social media application. One of ordinary skill in the art will appreciate that the server 102 may actually be a collection of servers for load distribution or other purposes. Similarly, the memory 104 and processor 106 may actually be a collection of memory devices and multiple processors. However, consistent with the above instructions for interpretation of the present application, a particular quantity of an element may be described or shown while the actual quantity of the element may differ. The social media system 100 may include a plurality of computing devices 108 of users of the social media system 100. One of ordinary skill in the art will appreciate that the computing devices 108, like the server 102, include memory and a processer. The computing devices 108 may be, for example, computers, mobile devices, and tablet devices.

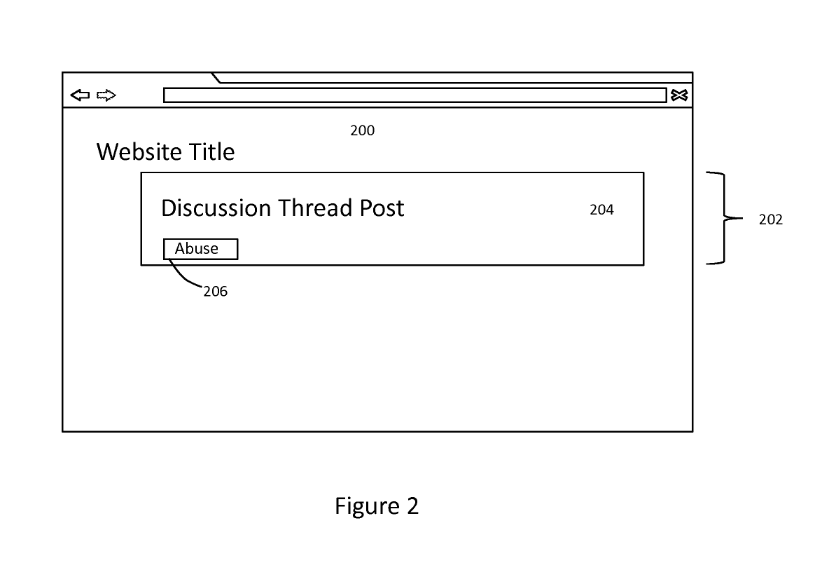

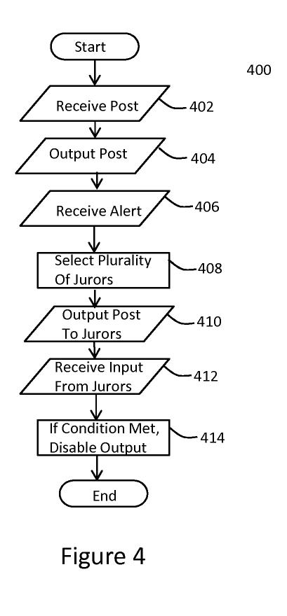

The computerized community-based social media moderation method may be implemented in reviewing a social media such as a website including a discussion forum. The social media posts reviewed in a discussion forum may be discussion forum posts. FIG. 2 is a schematic representation of a website 200 including a discussion forum 202 according to an exemplary embodiment of the present invention. FIG. 4 is a flowchart of an operation 400 of the website 200 according to an exemplary embodiment of the present invention. The website 200 may serve an online community of users. The website 200 may be hosted on the server 102 and accessed by the computing devices 108 of the users of the online community.

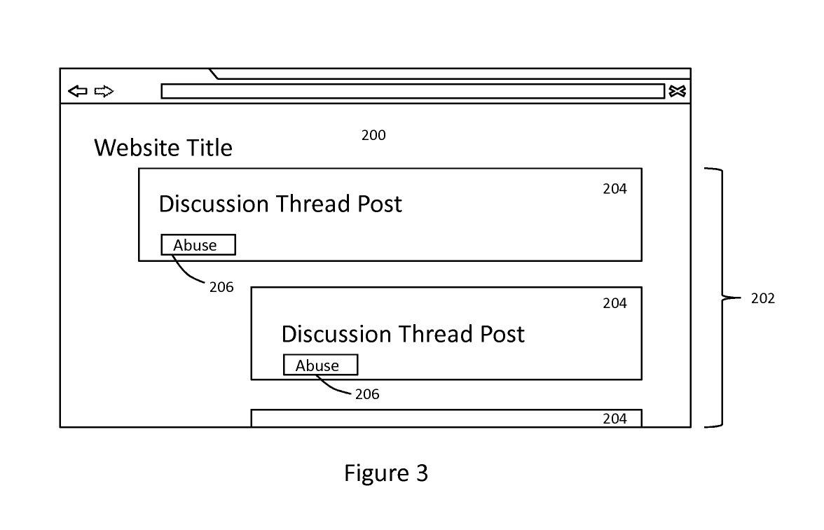

A user may post a discussion forum post 204 for other members of the online community to read. That is, in operation 402, the discussion forum post 204 may be received from the user into the memory 104 of the server 102. In operation 404, the discussion forum post 204 may be output to the computing devices 108 of the users of the online community. An exemplary post may read “Who will win the presidential election this cycle?” Because the discussion forum post 204 is a first post, the discussion forum post 204 may be considered a start to a thread. As shown in FIG. 3, follow up discussion forum posts 204 may be posted by other users with respect to the thread. The follow up posts may each be similarly received from a user into the memory 104 of the server 102 and output to the computing devices 108 of the online community of users.

Each discussion forum post 204 may include the content of the post itself as well as additional details such as time of post (not pictured), author of post (not pictured), and an abuse alert 206. If a user believes that the discussion forum post 204 is in violation of a standard of the online community, the user may select the abuse alert 206. In operation 406, an abuse alert 206 for a particular discussion forum post 204 may be received by the server 102 thereby indicating a potential violation of the standard of the online community.

Upon receipt of the abuse alert, a plurality of jurors may be selected. Specifically, in operation 408, instructions executed by the processor 106 of the server 102 may select a plurality of juror computing devices. It should be noted that an aspect of an embodiment is to select human jurors so as to receive human input in reviewing the flagged discussion forum post 204. The juror computing devices may be selected from among computing devices of the users of the online community that are currently visiting the website. The selection of the jurors may be performed according operations designed to have a randomizing effect. That is, in operation 408, the selecting of the plurality of computing devices may be performed according to a randomizing operation.

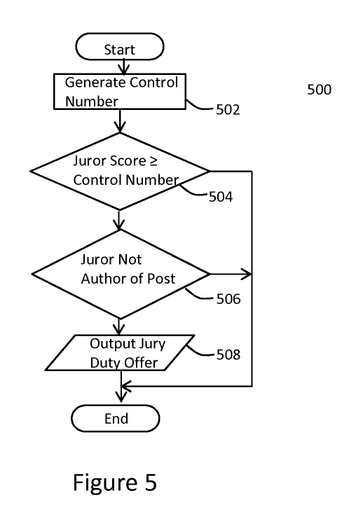

FIG. 5 is a flow chart of a randomizing operation 500 according to an exemplary embodiment of the present invention. In operation 502, instructions executed by the processor 106 of the server 102 may generate a control number. The control number may be generated using instructions designed to randomly generate a number. Instructions designed to randomly generate a number similar to simulating a dice may be used. The control number may be a number from 1 to 100. The generation of the control number may triggered by the next interaction received by the server from a computing device of a user of the online community. The user of the computing device that is the next to interact with the server 102 thereby triggers generation of the control number and also may become a first potential juror.

A juror score associated with a first potential juror may be compared with the control number. That is, in operation 504, a determination may be made whether the juror score of the first potential juror meets a predetermined condition with respect to the control number. The juror score may be a number that, in one embodiment may be assigned, and in another embodiment may be calculated based a history of the first potential juror's interactions with the website. For example, the juror score may be calculated based on a number of social media posts posted ever, a duration of membership in the online community, a number of posts posted in the last ninety days, a status as a paid subscriber in the online community, and a number of posts reviewed in the past 90 days. The juror score may be a number from 1 to 100. Alternative to juror score calculation, a predetermined juror score (e.g., 50) may be assigned to all potential jurors in the embodiment where the juror score is randomly assigned.

The predetermined condition of the juror score with respect to the control number may be based on a value comparison. If the juror score associated with the first potential juror is greater than or equal to the control number, the juror score associated with the first potential juror may meet the predetermined condition. Accordingly, the operation 500 may proceed to operation 506. If the juror score associated with the first potential juror is less than the control number, the juror score associated with the first potential juror may not meet the predetermined condition and the operation 500 may proceed to terminate.

The first potential juror may not be selected as a juror if the first potential juror authored the discussion forum post 204 generating the abuse alert 206 indicating a potential violation of the standard of the online community. In operation 506, a determination may be made whether the first potential juror did not post the social media post. If the first potential juror did not post the social media post, the operation may proceed to operation 508. If the first potential juror did post the social media post, the operation 500 may proceed to terminate.

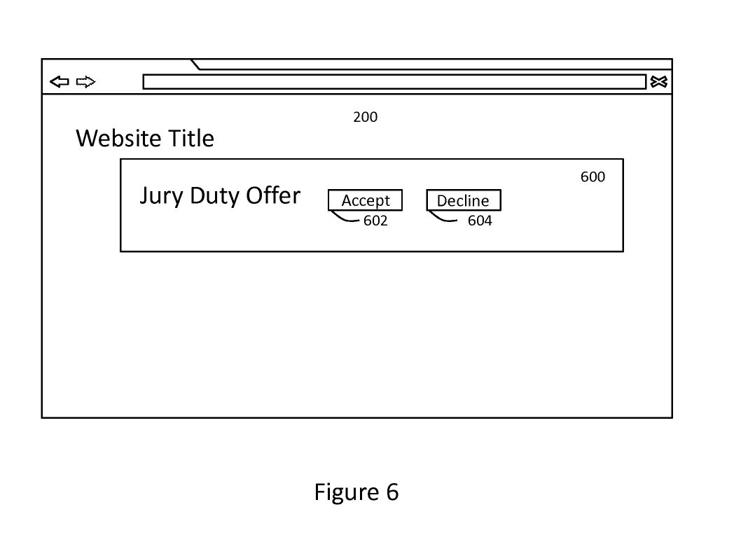

If the first potential juror is selected to jury duty, the first potential juror may receive a jury duty offer. In operation 508, the jury duty offer 600 (FIG. 6) may be output to the computing device of the first potential juror. The jury duty offer 600 may present a question asking if the user would like to serve as a juror. The jury duty offer 600 may include an accept control 602 and a decline control 604. If the user decides to serve as a juror, the accept control 602 displayed on the computing device of the first potential juror may be selected by the user. If the user decides to decline serving as a juror, the decline control may be selected. The jury duty offer 600 may include additional controls (not pictured), such as a control that may display more information about a computerized community-based social media moderation method.

The randomizing operation 500 may be repeated for additional potential jurors. In other words, the user of the computing device that is the next (after the first potential juror) to interact with the server 102 may again trigger generation of a control number and may also become the second potential juror. Operations 504, and if applicable, 506 and 508 may also repeat for the second potential juror potentially resulting in a second jury duty offer 600. The randomizing operation may repeat until a predetermined number of jurors have accepted jury duty. In an embodiment, the predetermined number of jurors may be six.

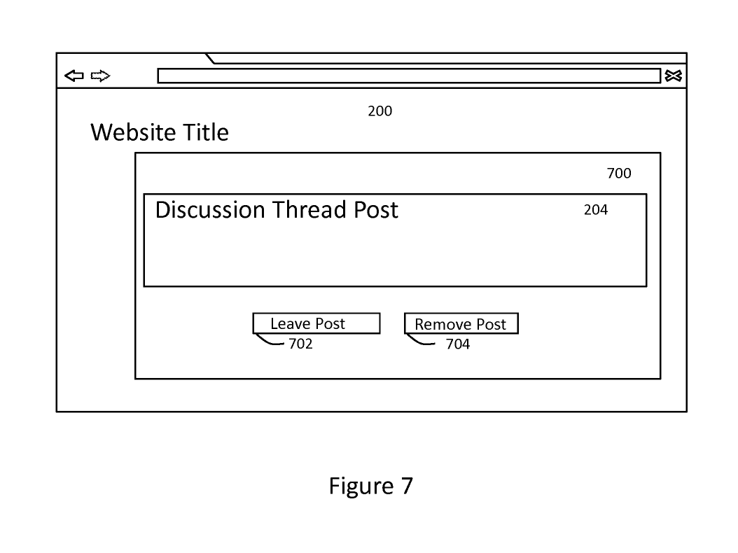

Turning to FIGS. 4 and 7, the particular discussion forum post 204 that was flagged in operation 406 thereby indicating a potential violation is displayed to the jurors. Specifically, in operation 410, the discussion forum post 204 is output to the plurality of juror computing devices for review of the social media post in light of the standard of the online community. The jurors may review the discussion forum post 204 in light of the standard of the community and may vote upon whether the discussion forum post 204 is a violation of the standard of the community or not. For example, the discussion forum post 204 may be displayed as part of a review area 700 and may be displayed with options such as “Post is okay: LEAVE IT ALONE” 702 and “Post is inappropriate: HIDE IT” 704. The selections of the jurors may be received from the plurality of jurors. That is, in operation 412, inputs regarding the discussion forum post may be received from the plurality of juror computing devices.

The jurors' votes may be used in determining whether or not to hide the particular discussion forum post 204. In operation 414, if the inputs regarding the discussion forum post 204 meet a predetermined condition, the outputting of the social media post to the plurality of social media user computing devices 108 may be disabled. The inputs regarding the social media post from the plurality of juror computing devices may meet the predetermined condition if a predetermined number of hide votes are received. In an embodiment, the predetermined number of hide votes may be four out of six votes. The inputs regarding the discussion forum post 204 from the plurality of juror computing devices may be selectively output to the author of the discussion forum post. For example, the inputs may be output to the author if the discussion forum post is hidden. Thereafter, the method 400 may terminate.

The foregoing description discloses only exemplary embodiments of the invention. Modifications of the above-disclosed embodiments of the present invention of which fall within the scope of the invention will be readily apparent to those of ordinary skill in the art. For example, although in the embodiments, the social media posts are described with reference to text posts, the social media posts may include alternative content (e.g., pictures and video). Further, although the operations of, e.g., the randomizing operation 500 are shown in a particular order; the order of the operations may be varied. Further, although political communication is discussed, the embodiments are widely applicable.

Accordingly, while the present invention has been disclosed in connection with exemplary embodiments thereof, it should be understood that other embodiments may fall within the spirit and scope of the invention as defined by the following claims claims and their equivalents.

What is claimed is:

1. A computerized community-based social media moderation method, comprising:
receiving a social media post into a computerized memory of a server;
outputting the social media post to a plurality of social media user computing devices of users belonging to an online community;
receiving an abuse alert regarding the social media post from one of the plurality of social media user computing devices, the abuse alert indicating a potential violation of a standard of the online community;
selecting, using instructions executed by a processor, a plurality of juror computing devices;
outputting the social media post to the plurality of juror computing devices for review of the social media post in light of the standard of the online community;
receiving inputs regarding the social media post from the plurality of juror computing devices; and
if the inputs regarding the social media post from the plurality of juror computing devices meet a predetermined condition, disabling the outputting of the social media post to the plurality of social media user computing devices belonging to the online community,
wherein the selecting of the plurality of juror computing devices is performed according to a randomizing operation.

2. The method of claim 1, wherein the social media post comprises a website discussion forum post.

3. The method of claim 1, wherein the randomizing operation comprises:
generating a control number;
if a juror score associated with a first potential juror meets a predetermined condition with respect to the control number and if the first potential juror did not post the social media post, outputting a jury duty offer to the first potential juror; and
repeating the outputting operation for each additional potential juror until a predetermined number constituting the plurality of juror computing devices is reached.

4. The method of claim 3, further comprising:
repeating the generating operation for each additional potential juror.

5. The method of claim 4, wherein the juror score is calculated as a score from 1 to 100.

6. The method of claim 5, wherein the juror score is calculated based on a history of interactions of the first potential juror with the server.

7. The method of claim 5, wherein the juror score is calculated based on a number of social media posts posted ever, a duration of membership in the online community, a number of posts posted in the last ninety days, a status as a paid subscriber in the online community, and a number of posts reviewed within the previous ninety days.

8. The method of claim 5, wherein the generating of a control number comprises:
randomly generating the control number,
wherein if the juror score associated with the first potential juror is greater than or equal to the control number, the juror score associated with the first potential juror meets the predetermined condition.

9. The method of claim 3, wherein the first potential juror comprises a next one of the plurality of social media user computing devices to interact with the server.

10. The method of claim 1, wherein the inputs regarding the social media post from the plurality of juror computing devices meet the predetermined condition if a predetermined number of hide votes are received.

11. A computerized community-based social media moderation method, comprising:
receiving a social media post into a computerized memory of a server;
outputting the social media post to a plurality of social media user computing devices of users belonging to an online community;
receiving an abuse alert regarding the social media post from one of the plurality of social media user computing devices, the abuse alert indicating a potential violation of a standard of the online community;
generating a control number;
if a juror score associated with a first potential juror meets a predetermined condition with respect to the control number and if the first potential juror did not post the social media post, outputting a jury duty offer to the first potential juror;
repeating the generating and outputting operations for each additional potential juror until a predetermined number constituting a plurality of juror computing devices is reached;
outputting the social media post to the plurality of juror computing devices for review of the social media post in light of the standard of the online community;
receiving inputs regarding the social media post from the plurality of juror computing devices; and
if the inputs regarding the social media post from the plurality of juror computing devices meet a predetermined condition, disabling the outputting of the social media post to the plurality of social media user computing devices belonging to the online community.

12. The method of claim 11, wherein the social media post comprises a website discussion forum post.

13. The method of claim 11, wherein the juror score is calculated as a score from 1 to 100.

14. The method of claim 13, wherein the juror score is calculated based on a history of interactions of the first potential juror with the server.

15. The method of claim 13, wherein the juror score is calculated based on a number of social media posts posted ever, a duration of membership in the online community, a number of posts posted in the last ninety days, a status as a paid subscriber in the online community, and a number of posts reviewed within the previous ninety days.

16. The method of claim 13, wherein the generating of a control number comprises:
randomly generating the control number,
wherein if the juror score associated with the first potential juror is greater than or equal to the control number, the juror score associated with the first potential juror meets the predetermined condition.

17. The method of claim 11, wherein the first potential juror comprises a next one of the plurality of social media user computing devices to interact with the server.

18. The method of claim 11, wherein the inputs regarding the social media post from the plurality of juror computing devices meet the predetermined condition if a predetermined number of hide votes are received.

19. A computerized community-based social media moderation method, comprising:
receiving a website discussion forum post into a computerized memory of a server;
outputting the website discussion forum post to a plurality of website discussion forum computing devices of users belonging to an online community;
receiving an abuse alert regarding the website discussion forum post from one of the plurality of website discussion forum computing devices, the abuse alert indicating a potential violation of a standard of the online community;
generating a control number from 1 to 100;
if a juror score from 1 to 100 associated with a first potential juror is greater than or equal to the control number, the first potential juror did not post the website discussion forum post, and the first potential juror is a registered member of the online community, outputting a jury duty offer to the first potential juror;
repeating the generating and outputting operations for each additional potential juror until a predetermined number constituting a plurality of juror computing devices is reached;
outputting the website discussion forum post to the plurality of computing devices for review of the website discussion forum post in light of the standard of the online community;
receiving inputs regarding the website discussion forum post from the plurality of juror computing devices; and
if a majority of inputs regarding the website discussion forum post from the plurality of juror computing devices include a hide vote, disabling the outputting of the website discussion forum post to the plurality of website discussion forum user computing devices belonging to the online community,
wherein the first potential juror comprises a next one of the plurality of social media users to interact with the server.

20. A computerized community-based social media moderation system, comprising:
a memory;
a processor; and
instructions stored in the memory to be executed by the processor and to:
receive a website discussion forum post into the memory;
output the website discussion forum post to a plurality of website discussion forum computing devices of users belonging to an online community;
receive an abuse alert regarding the website discussion forum post from one of the plurality of website discussion forum computing devices, the abuse alert indicating a potential violation of a standard of the online community;
generate a control number from 1 to 100;
if a juror score from 1 to 100 associated with a first potential juror is greater than or equal to the control number, the first potential juror did not post the website discussion forum post, and the first potential juror is a registered member of the online community, output a jury duty offer to the first potential juror;
repeat the generating and outputting for each additional potential juror until a predetermined number constituting a plurality of juror computing devices is reached;
output the website discussion forum post to the plurality of computing devices for review of the website discussion forum post in light of the standard of the online community;
receive inputs regarding the website discussion forum post from the plurality of juror computing devices; and
if a majority of inputs regarding the website discussion forum post from the plurality of juror computing devices include a hide vote, disable the outputting of the website discussion forum post to the plurality of website discussion forum user computing devices belonging to the online community,
wherein the first potential juror comprises a next one of the plurality of social media users to interact with the processor.
